(19) United States
(12) Patent Application Publication
(10) Pub. No.: US 2013/0205914 A1
(43) Pub. Date: Aug. 15, 2013

(54) SENSOR ARRANGEMENT AND METHOD FOR MONITORING AN INFUSION PROCESS

(71) Applicant: Casper Houmann Jensen, Aalborg (DK)

(72) Inventor: Casper Houmann Jensen, Aalborg (DK)

(21) Appl. No.: 13/763,756

(22) Filed: Feb. 11, 2013

(30) Foreign Application Priority Data
Feb. 14, 2012 (EP) 12155365.5

(51) Int. Cl. G01F 1/80

(52) U.S. Cl. CPC G01F 1/80
USPC 73/861.42

(57) ABSTRACT

A sensor arrangement for monitoring an infusion process in a flow channel and a method for monitoring an infusion process in a flow channel are described. The sensor arrangement includes a pressure sensor with a sensor interface and a plug. The plug has an inner cavity with an inlet and an outlet. The inlet of the plug is in flow connection with the flow channel and the outlet of the plug is located at the sensor interface.

### CROSS REFERENCE TO RELATED APPLICATIONS

This application claims priority of European Patent Application No. 12155365.5 EP filed Feb. 14, 2012. All of the applications are incorporated by reference herein in their entirety.

### FIELD OF THE INVENTION

A sensor arrangement for monitoring an infusion process, a mould for vacuum assisted resin transfer moulding (VARTM) and a method for monitoring an infusion process are provided. The sensor arrangement, the mould and the method are for example applicable in a process for manufacturing a composite, for instance a wind turbine rotor blade, using vacuum assisted resin transfer moulding.

### BACKGROUND ART

One of the major tasks in the casting process of a large composite structure such as a wind turbine rotor blade is to ensure a correct flow of resin in the composite fibre structure and to ensure that all volume of the structure is soaked before ending the application of resin. One way to ensure that these tasks can be fulfilled is to monitor the flow of resin at selected points of the structure.

Three known different techniques for this will now be described with reference to FIGS. 1 to 3. FIGS. 1 to 3 schematically show part of a mould in a sectional view during vacuum assisted resin transfer moulding. The shown moulds 1 comprise an inner surface 7 and an outer surface 8. Glass fibre material 2 was placed onto the inner surface 7. The fibre material 2, which may additionally comprise for an increased stability of the composite, is covered by a plastic bag or vacuum bag 3. Resin is infused into the cavity 13 between the plastic bag 3 and the inner surface 7 of the mould 1, preferably by vacuum assisted resin transfer moulding.

In FIG. 1 the mould 1 comprises an air outlet 4 between the inner surface 7 and an outer surface 8 of the mould 1. The air outlet 4 is connected to an inlet 9 of a hose 5. The hose 5 further comprises an outlet 10. The outlet 10 is connected to a pressure sensor 6. The pressure between the inner surface 7 of the mould 1 and the plastic bag or vacuum bag 3 is measured outside the mould 1. Furthermore, the air outlet 4 or the hose 5 may be connected to a vacuum pump. The pressure measured by the sensor 6 indicates the progress of the infusion process. The technique as shown in FIG. 1 is very indirect and slow. Moreover, it requires a change of the hose 5 after each infusion process. The change of the hose 5 can be very difficult beneath a mould 1.

In FIG. 2, a chemical resistant sensor 16 is placed in the mould 1. The sensor 16 needs to be cleaned in an acetone bath after each use and is thus very difficult to demount and maintain.

In FIG. 3 the measurement of the progress of the infusion process is performed through the plastic bag 3. This requires a risky connection through the essential bag 3 and cannot be implemented in the integral blade concept, which means using a closed mould for vacuum assisted resin transfer moulding. In FIG. 3 a seal 11 is located between the used sensor 6 and the resin flow channel between the plastic bag 3 and the inner surface 7 of the mould 1. There is a risk of resin attaching to the seal or the sensor during infusion and thereby forcing maintenance, for example mechanical or chemical maintenance.

### DESCRIPTION OF THE INVENTION

It is a first objective to provide an improved sensor arrangement for monitoring an infusion process in a flow channel which especially is easy to demount and maintain. It is a second objective to provide an advantageous mould for vacuum assisted resin transfer moulding. A third objective is to provide an improved method for monitoring an infusion process in a flow channel, for example in a mould during a vacuum assisted resin transfer moulding process.

The first objective is solved by a sensor arrangement, the second objective is solved by a mould, and the third objective is solved by a method for monitoring an infusion process as claimed in the independent claims. The depending claims define further developments.

The sensor arrangement for monitoring an infusion process in a flow channel comprises a pressure sensor and a plug. The pressure sensor comprises a sensor interface. The plug comprises an inner cavity or flow channel with an inlet and an outlet. To distinct the flow channel of the infusion process from the flow channel in the plug, the flow channel in the plug will be named as inner cavity. The inlet of the plug is in flow connection with the flow channel. The outlet of the plug is located at the sensor interface. For example, the outlet of the plug is facing towards the sensor interface. By means of the outlet of the plug a mechanical contact between the infused liquid and the sensor interface will be obtained to realise the pressure measurement.

The sensor arrangement can for example be used for monitoring the resin flow or the pressure in a wind turbine blade casting process. The combination of the pressure sensor with a described plug has the advantage, that the sensor with the plug can be integrated into the mould. After an infusion process only the plug need to be demounted and maintained. This can easily be done by screwing the plug out from the inner surface of the used mould or more generally of the used flow channel.

Moreover, the plug prevents the used glass fibre material which is placed in the mould during a casting process of a composite, for example a wind turbine rotor blade, from pressing on the sensor interface. This enables the sensor to measure the liquid and gas or vacuum pressure during the process. The plug can be replaced after each casting. This can be done from inside the mould, where all common maintenance is performed as well. Thus, it is more comfortable and less time consuming than for example changing a hose as mentioned in conjunction with the description of FIG. 1. Furthermore, the plug in combination with a filter also enables a more direct measurement in the process, which the previously described hose does not, since the signal is delayed or distorted depending on the combination of length, height and inside diameter of the hose.

Advantageously the sensor arrangement comprises a means, for example a filter or cloth, to prevent the plug from applying pressure on the sensor interface. The used means can be located between the outlet of the plug and the sensor interface.

Furthermore, the sensor arrangement can comprise a means, for example a filter or cloth, to prevent an infused liquid, for example resin, from coming in direct contact with the sensor interface. Preventing the liquid from coming in direct contact with the sensor interface reduces significantly the wear of the sensor and reduces the possibility of any liquid, for example resin, to attach to the sensor. Thereby the maintenance which is necessary in the state of the art solutions as described with reference to FIGS. 2 and 3 can be reduced or eliminated. The filter or cloth also binds or holds the liquid, for example resin, to the plug when screwing it out after the casting process is done. The result is a clean sensor with minimal maintenance required.

The means to prevent the plug from applying pressure on the sensor interface and/or the means to prevent an infused liquid from coming in direct contact with the sensor interface can be realized by the same means, for example a filter. This means is preferably part of the plug and may hold the resin to the plug when demounting it out after the infusion process or casting process. The means, for example the filter, can be mounted with glue.

The sensor arrangement may further comprise an insert element which at least partly surrounds the sensor and/or the plug and/or the means to prevent an infused liquid from coming in direct contact with the sensor interface and/or the means to prevent the plug from applying pressure on the sensor interface. Preferably, the insert element partly surrounds the sensor and the plug and a filter which is located between the sensor interface and the plug. The filter may be mounted with glue and an edge sealing to a sealing surface of the insert element. The sealing surface can prevent the plug from applying pressure on the sensor.

The insert element may comprise metal or may consist of metal. It can be integrated in the wall of a mould or flow channel. The sensor can be mounted from outside into the insert element, which can be located in the mould. This means that the sensor can be mounted from the outer surface of the mould. The sensor can be aligned flush with a sealing surface inside the insert element. The plug, for example a threaded plug can be mounted from the inside of the mould, which means from the inner surface of the mould. The plug provides that the infused liquid, for example resin, reaches the sensor interface.

Generally, the insert element can be insertable into a corresponding opening in a surface or wall of the flow channel. Preferably the flow channel comprises part of a mould and the insert element is insertable into a corresponding opening in a surface of the mould. The mould may be applicable for casting a composite. As already mentioned, the insert element and/or the plug may comprise a sealing surface which is aligned to flush with the sensor interface.

The metal insert provides a rigid sealing surface for the plug to be tightened against. This holds the filter or similar means to prevent the infused liquid from coming in direct contact with the sensor interface and/or to prevent the plug from applying pressure on the sensor interface in place. When the sensor is flush mounted it prevents the filter or similar means from being detached from the plug, since the force from the liquid is transferred to the sensor and the sealing surface directly. Instead of using a sealing surface the sensor interface on the sensor surface can be reduced. In this case the plug can seal on the sensor instead of on the insert element.

The mould for vacuum assisted resin transfer moulding comprises a sensor arrangement as previously described. The mould has the same features, properties and advantages as the previously described sensor arrangement. Preferably the mould comprises an inner surface and the sensor arrangement is integrated into a wall of the mould such that a surface of the plug comprising the inlet forms part of the inner surface of the mould.

The method for monitoring an infusion process in a flow channel comprises the steps of a) placing a pressure sensor with a sensor interface and a plug comprising an inner cavity with an inlet and an outlet such in an opening in a surface of the flow channel that the inlet of the plug is in flow connection with the flow channel and the outlet of the plug is located at the sensor interface, b) infusing a liquid into the flow channel, and c) measuring the pressure at the sensor interface. The method can be performed using the previously described sensor arrangement.

The plug can face towards the sensor interface. The plug can be prevented from applying pressure on the sensor interface. This can be realized by using a means which is located between the outlet of the plug and the sensor interface, for example a filter or cloth.

Furthermore, an infused liquid, for example resin, can be prevented from coming in direct contact with the sensor interface, for example by means of a filter or cloth. This reduces time and costs for maintenance.

Advantageously an insert element, for example a metal insert element, can be inserted into a corresponding opening in the surface of the flow channel. The insert element at least partly surrounds the sensor and/or the plug and/or the used means for preventing an infused liquid from coming in direct contact with the sensor interface and/or the used means for preventing the plug from applying pressure on the sensor interface. Preferably the insert element is inserted into a corresponding opening in a surface of a mould forming at least part of the flow channel, for example a mould for casting a composite. The sensor interface can be sealed, for example by means of the plug or the insert element.

Advantageously, a resin infusion process is monitored in a vacuum assisted resin transfer moulding process by placing a sensor arrangement as previously described into a corresponding opening in the inner surface of a used mould and the pressure of the injected resin is measured at the sensor interface. After finishing the casting process the plug can be demounted.

### Embodiment

The aspects defined above and further aspects are apparent from the examples of embodiment to be described hereinafter and are explained with reference to the examples of embodiment. The claimed invention will be described in more detail hereinafter with reference to examples of embodiment but to which the claimed invention is not limited.

Further features, properties and advantages of the present claimed invention will become clear from the following description in conjunction with the accompanying drawings. All features are advantageous separate or in combination with each other.

### BRIEF DESCRIPTION OF THE DRAWINGS

FIG. 1 schematically shows in a sectional view part of a mould during manufacturing a wind turbine rotor blade.

FIG. 2 schematically shows in a sectional view part of a mould equipped with a chemical resistant sensor during the process of manufacturing a wind turbine rotor blade.

FIG. 3 schematically shows part of a mould during a process of manufacturing a wind turbine rotor blade in a sectional view comprising a sensor located at a vacuum bag.

FIG. 4 schematically shows part of a mould with a sensor arrangement in a sectional view.

FIG. 5 schematically shows a plug in a perspective view.

FIG. 6 schematically shows an insert element in a perspective view.

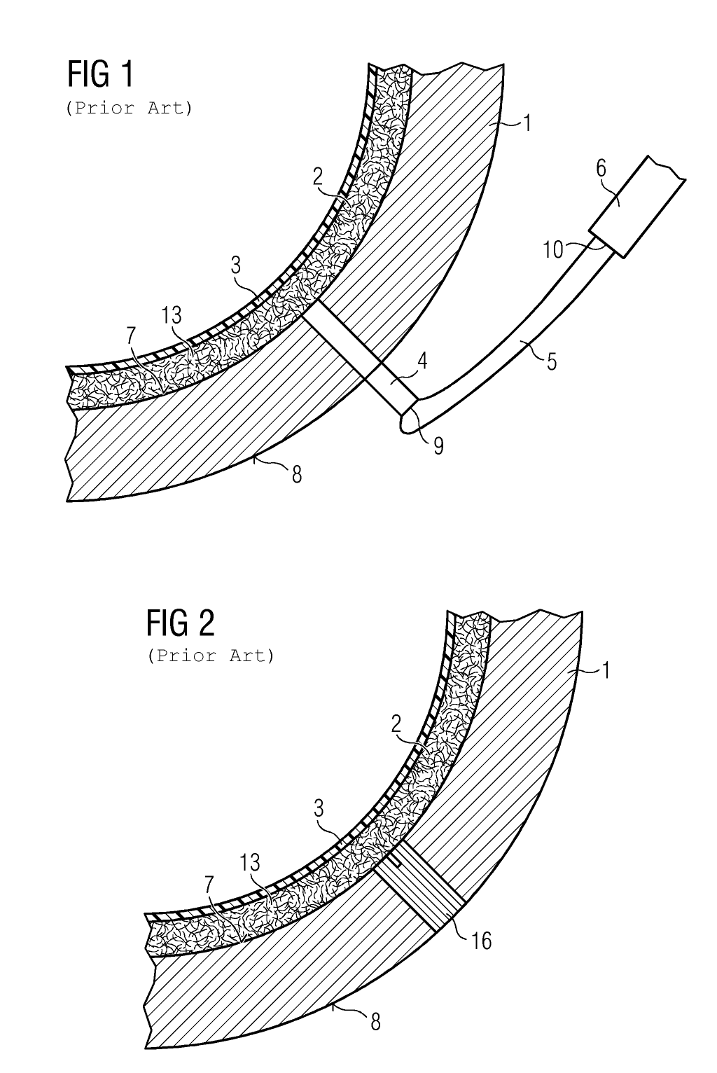

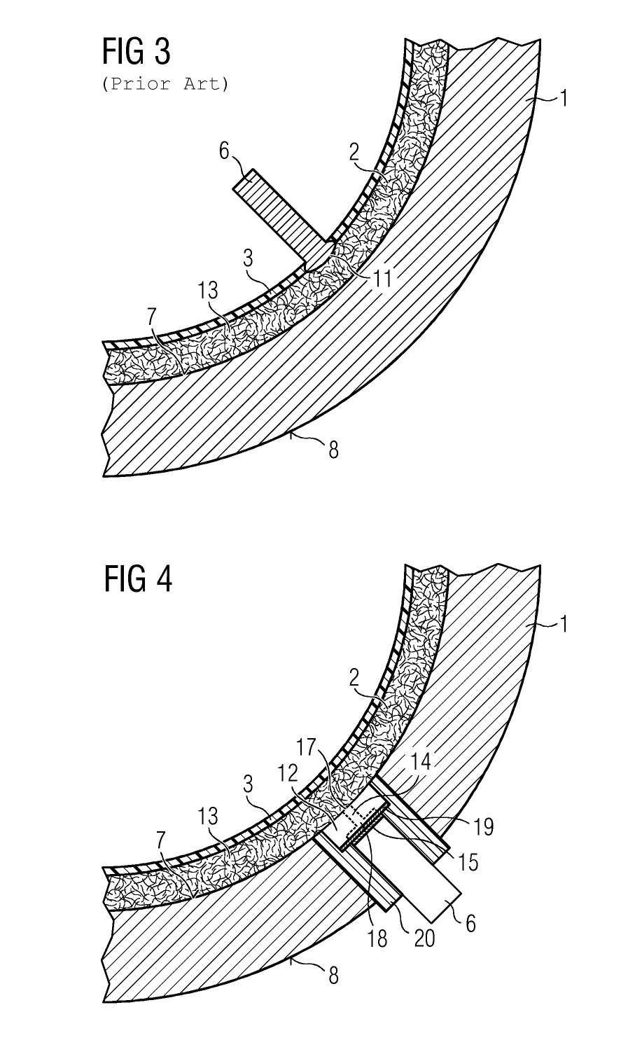

### DETAILED DESCRIPTION OF EMBODIMENT

An embodiment will now be described with reference to FIGS. 4 to 6. FIG. 4 schematically shows part of a mould 1 for manufacturing a composite, for example a wind turbine rotor blade, by means of vacuum assisted resin transfer moulding in a sectional view. The mould 1 comprises an inner surface 7 and an outer surface 8. A number of glass fibre layers 2 are laid onto the inner surface 7 of the mould 1. Additionally, balsa can be integrated into the glass fibre material 2. A plastic bag or vacuum bag 3 is laid onto the glass fibre material and/or balsa material 2.

A sensor arrangement is integrated into the mould 1. The sensor arrangement comprises a metal insert element 20. The metal insert element 20 is placed into a corresponding hole in the mould 1. The metal insert element 20 extends from the inner surface 7 to the outer surface 8 of the mould 1.

Inside the metal insert element 20 a pressure sensor 6 comprising a sensor interface 15 is located. The sensor interface 15 is facing towards the glass fibre material 2. A plug 12 is located between the sensor interface 15 and the glass fibre material 2. The plug 12 is also located inside of the metal insert 20. The plug 12 comprises a flow channel or inner cavity 14 with an inlet 17 and an outlet 18.

Between the inner surface 7 of the mould 1 and the plastic or vacuum bag 3 a flow channel 13 for distributing resin is formed. The inlet 17 of the flow channel or inner cavity 14 of the plug 12 faces towards the flow channel 13 and is in flow connection with this resin distribution channel. The outlet 18 of the inner cavity or flow channel 14 in the plug 12 is located at the sensor interface 15 and provides that the pressure inside the resin distribution channel 13 can be measured by means of the sensor 6.

Moreover, a filter or cloth 19 is located between the outlet 18 of the plug 12 and the sensor interface 15. The filter or cloth 19 prevents direct contact between the sensor interface 15 and the infused resin, and equally holds the resin to the plug 12 when demounting the plug after the casting process. The filter or cloth 19 is mounted with glue and an edge sealing to the sealing surface of the metal insert. The sealing surface 21 of the insert element 20, which is shown in FIG. 6, prevents the plug 12 from applying pressure on the sensor 6.

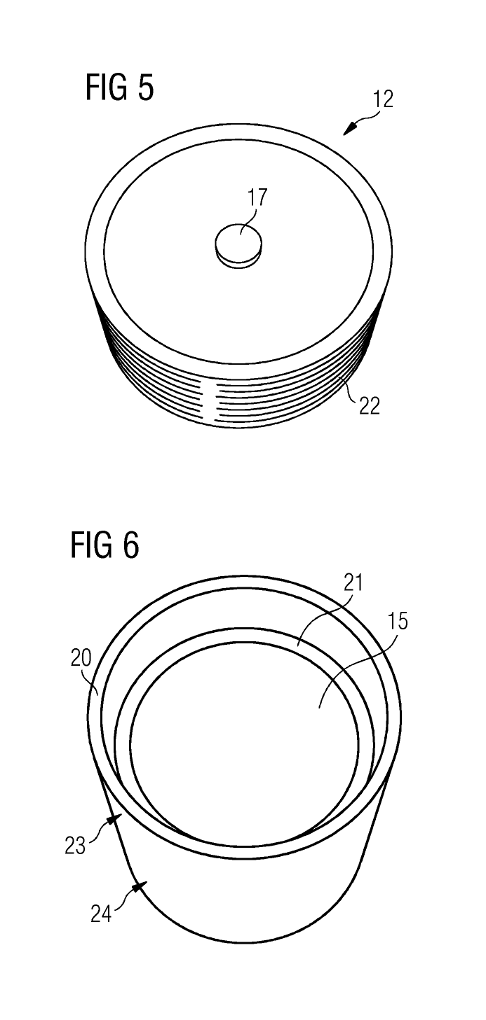

FIG. 5 schematically shows the plug 12 in a perspective view. The top surface which is aligned flush with the inner surface 7 of the mould 1 when mounted is visible in FIG. 5. The plug 12 has the shape of a cylinder. It comprises a screw thread 22 at its curved surface area. The top surface comprises the inlet 17.

FIG. 6 schematically shows the metal insert element 20 in a perspective view. The top surface as it is visible from the inner surface 7 of the mould 1. The metal insert 20 has the general shape of a hollow cylinder. It comprises an upper portion 23 for holding the plug 12 and a lower portion 24 for holding the sensor 6. The upper portion 23 has a larger inner diameter than the lower portion 24. In FIG. 6 the sensor 6 is located inside of the lower portion 24 of the metal insert 20. The sensor interface 15 is visible. At the changeover from the lower portion to the upper portion the metal insert 20 comprises a sealing surface 21 for the plug 12. The sealing surface 21 prevents the plug 12 from applying pressure on the sensor 6.

The claimed invention has the advantage, that a system for monitoring the progress of an injection process is provided which is very easy to mount and demount and which needs less maintenance than previously known solutions.

1. Sensor arrangement for monitoring an infusion process in a flow channel, comprising:
a pressure sensor with a sensor interface and a plug comprising an inner cavity with an inlet and an outlet,
wherein the inlet of the plug is in flow connection with the flow channel, and
wherein the outlet of the plug is located at the sensor interface.

2. The sensor arrangement as claimed in claim 1, wherein the sensor arrangement comprises means for preventing the plug from applying pressure on the sensor interface.

3. The sensor arrangement as claimed in claim 1, wherein the sensor arrangement comprises means for preventing an infused liquid from coming in direct contact with the sensor interface.

4. The sensor arrangement as claimed in claim 1, further comprising:
an insert element which at least partly surrounds the pressure sensor and/or the plug and/or means for preventing an infused liquid from coming in direct contact with the sensor interface and/or means for preventing the plug from applying pressure on the sensor interface.

5. The sensor arrangement as claimed in claim 4, wherein the insert element is insertable into an opening in a surface of the flow channel.

6. The sensor arrangement as claimed in claim 4, wherein the flow channel comprises part of a mould and wherein the insert element is insertable into an opening in a surface of the mould.

7. The sensor arrangement as claimed in claim 4, wherein the insert element and/or the plug comprise(s) a sealing surface which is flush aligned with the sensor interface.

8. A mould for Vacuum Assisted Resin Transfer Moulding comprising a sensor arrangement as claimed in claim 1.

9. A method of monitoring an infusion process in a flow channel, comprising:
placing a pressure sensor with a sensor interface and a plug comprising an inner cavity with an inlet and an outlet into an opening of a surface of the flow channel such that the inlet of the plug is in flow connection with the flow channel and the outlet of the plug is located at the sensor interface,
infusing a liquid into the flow channel, and
measuring the pressure at the sensor interface.

10. The method as claimed in claim 9, further comprising:
preventing the plug from applying pressure on the sensor interface.

11. The method as claimed in claim 9, further comprising:
preventing an infused liquid from coming in direct contact with the sensor interface.

12. The method as claimed in claim 9, further comprising:
inserting an insert element into an opening of the surface of the flow channel such that the insert element at least partly surrounds the sensor and/or the plug and/or means for preventing an infused liquid from coming in direct contact with the sensor interface and/or means for preventing the plug from applying pressure on the sensor interface.

13. The method as claimed in claim 12, wherein the insert element is inserted into an opening of a surface of a mould which forms at least part of the flow channel.

14. The method as claimed in claim 9, further comprising:
sealing the sensor interface.

15. The method as claimed in claim 9, further comprising:
monitoring a resin infusion process in a vacuum assisted resin transfer moulding process by placing the sensor arrangement into an opening of an inner surface of a mould and measuring a pressure of injected resin at the sensor interface.
